(19) United States
(12) Patent Application Publication
(10) Pub. No.: US 2013/0283717 A1
(43) Pub. Date: Oct. 31, 2013

(54) MULTI-PURPOSE REDUCERS, SYSTEMS AND METHODS FOR PRODUCTION THEREOF

(71) Applicant: Patrick George Smith, Raleigh, NC (US)

(72) Inventor: Patrick George Smith, Raleigh, NC (US)

(73) Assignee: PERGO (EUROPE) AB, TRELLEBORG (SE)

(21) Appl. No.: 13/457,111

(22) Filed: Apr. 26, 2012

(51) Int. Cl. E04B 1/68; B23C 3/00; B29C 65/48; B23P 13/00

(52) U.S. Cl. 52/465; 29/557; 409/131; 156/196

(57) ABSTRACT

The present subject matter relates to systems and methods for covering a gap between two floor elements having different flooring heights. A multi-purpose reducer for this purpose can include a foot configured to fit in a gap between adjacent floor elements, a first arm extending in a first direction from the foot, and a second arm extending in a second direction substantially perpendicularly from the foot. The first arm can define a first thickness, and the second arm defining a second thickness less than the first thickness. In addition, the first arm can include a lower surface that can be angled with respect to a plane perpendicular to the foot.

### TECHNICAL FIELD

The subject matter disclosed herein relates generally to flooring, and more particularly to floor strips, such as a dilatation profile, a transition profile, or a finishing profile, and methods for the production thereof.

### BACKGROUND

Hard surface floors, such as wood or laminate flooring have become increasingly popular. As such, many different types of this flooring have been developed. Generally, this type of flooring is assembled by providing a plurality of similar panels. The differing types of panels that have developed, of course, may have differing depths and thicknesses. The same is true when a laminate floor (often referred to as a “floating floor”) abuts another hard surface, such as a resilient surface (such as vinyl), tile or another laminate surface, a ceramic surface, or other surface (e.g., natural wood flooring). Thus, when laminate panels having different thicknesses or different floor covering materials are placed adjacent to a laminate floor, transition moldings are often used to create a transition therebetween.

Additionally, one may desire to install floor panels adjacent to an area with different types of material. For example, it may be desirable to have one type of flooring in a kitchen (e.g., solid wood, resilient flooring, laminate flooring or ceramic tile), a different appearance in an adjacent living room (e.g., linoleum or carpeting), and an entirely different look in an adjacent bath. Therefore, it has become necessary to develop a type of molding or floor strip that could be used as a transition from one type of flooring to another.

Conventional floor strips do not adequately provide a transition between differing floor types, however, because they cannot adequately cover the gap between the differing floor coverings or the differing heights of the floor elements. It is also a problem for sellers of floor strips to inventory differing types of transition profiles, especially in a pattern or color to match a single floor. Thus, it would be of benefit to reduce the number of molding profiles that need to be kept in inventory by a seller or installer of laminate flooring.

### SUMMARY

In accordance with this disclosure, devices, systems and methods for covering a gap between two floor elements having different flooring heights are provided. In one aspect, multi-purpose reducer can comprise a foot configured to fit in a gap between adjacent floor elements, a first arm extending in a first direction from the foot, and a second arm extending in a second direction substantially perpendicularly from the foot. The first arm can define a first thickness, and the second arm can define a second thickness less than the first thickness. In addition, the first arm can comprise a first lower surface that forms an acute angle with respect to a plane perpendicular to the foot.

In another aspect, a flooring system for covering a gap between two floor elements covering a subsurface and having different flooring heights is provided. The system can comprise a multi-purpose reducer comprising a foot configured to fit in a gap between a first floor element and a second floor element covering a subsurface, a first arm extending in a first direction from the foot towards the first floor element, and a second arm extending in a second direction substantially perpendicularly from the foot towards the second floor element. The first arm can define a first thickness, and the second arm can define defining a second thickness less than the first thickness. The first arm can also comprise a first lower surface that forms an acute angle with respect to a plane perpendicular to the foot. The system can further comprise a securing element coupled to the subsurface between the first floor element and the second floor element, the securing element configured for maintaining the foot in a position between the first floor element and the second floor element.

In yet another aspect, a method for producing a multi-purpose reducer for covering a gap between two floor elements having different flooring heights is provided. The method can comprise producing a longitudinal carrier having an upper surface defining a first end having a substantially sloped profile and a second end having a substantially planar profile, providing a decorative surface on the carrier, shaping the carrier to define a foot, shaping the first end of the carrier to define a first arm extending in a first direction from the foot, the first arm defining a first thickness, and the first arm comprising a first lower surface that forms an acute angle with respect to a plane perpendicular to the foot, and shaping the second end of the carrier to define a second arm extending in a second direction substantially perpendicularly from the foot, where the second arm can define a second thickness less than the first thickness.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1A is a perspective view of a multi-purpose reducer according to an embodiment of the presently disclosed subject matter;

FIG. 1B is a side view of a multi-purpose reducer according to an embodiment of the presently disclosed subject matter; and

FIGS. 2A through 2F are side views of various stages in a procedure for producing a multi-purpose reducer according to an embodiment of the presently disclosed subject matter.

### DETAILED DESCRIPTION

The subject matter disclosed herein provides devices, systems and methods for floor strips. A floor strip, such as a dilatation profile, a transition profile, or a finishing profile, features of the floor strip, and methods for the production thereof are disclosed herein. In one aspect, a multi-purpose reducer is disclosed for providing a transition between rooms having different types of flooring (e.g., between carpet and tile) or different heights or textures of floor elements.

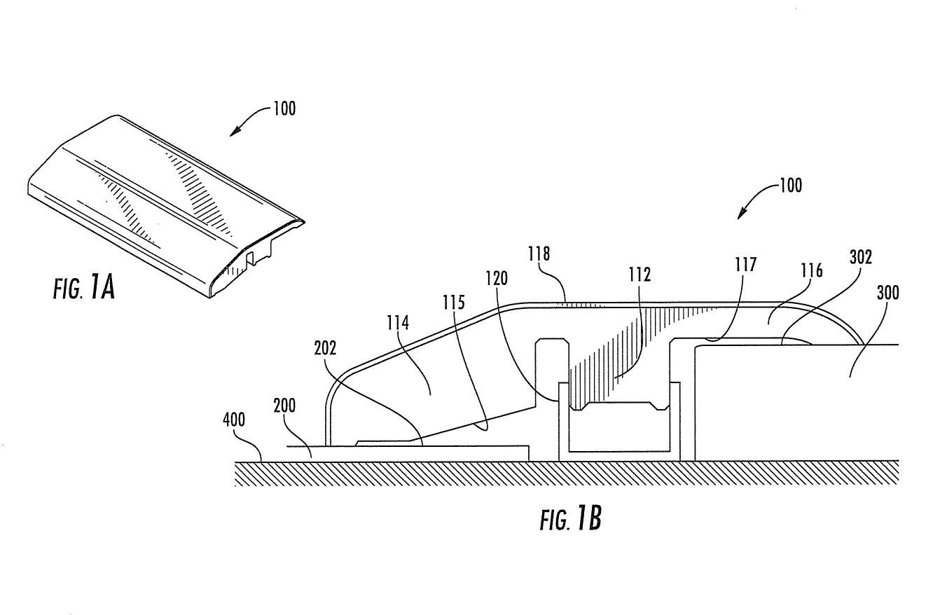

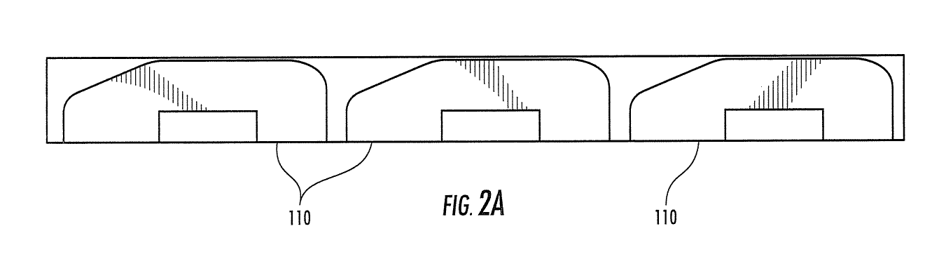

Referring to FIGS. 1A and 1B, a multi-purpose reducer, generally designated 100, is provided. As shown in FIG. 1B, reducer 100 can comprise a foot 112 extending as a rib along a longitudinal axis of reducer 100 and configured to fit in a gap between adjacent floor elements. For instance, reducer 100 can be configured for attachment between two differing sets of floor elements, such as a comparatively lower or thinner first floor element 200 and a comparatively higher or thicker second floor element 300, all on a subfloor 400. First and second floor elements 200 and 300 can be any type of flooring designed to be used as a floor or placed over a subfloor such as subfloor 400 (e.g., tile, linoleum, laminate flooring, concrete slab, parquet, vinyl, turf, composite, or hardwood). Laminate floors, for example, are not attached to subfloor 400, but rather are considered to be “floating floors”.

Reducer 100 can further comprise a first arm 114 extending in a first direction with respect to foot 112 and a second arm 116 extending in a generally perpendicular second direction with respect to foot 112. For instance, foot 112, first arm 114, and second arm 116 can form a general T-shape, with first and second arms 114 and 116 forming the upper structure and foot 112 forming the lower structure. Although foot 112 is shown as being positioned “off center” with respect to first and second arms 114 and 116, foot 112 can be placed at a midpoint of reducer 100, or anywhere in between, as desired.

Due to the differing heights of first and second floor elements 200 and 300, reducer 100 can be used to provide a smooth transition therebetween. In this regard, first arm 114 and second arm 116 can be designed to account for the respective heights of first and second floor elements 200 and 300. Specifically, first arm 114 can be shaped and configured, all of first arm 114 or at least a portion of first arm 114, to slope downwardly at an angle with respect to a plane perpendicular to the direction of extension of foot 112 (i.e., a plane parallel to second arm 116). In addition, first arm 114 can have a first thickness that is comparatively greater than a second thickness of second arm 116. As a result, the increased thickness of first arm 114 relative to second arm 116 can result in first arm 114 being able to contact and cover an edge of a first upper surface 202 of first floor element 200. In contrast, second arm 116 can extend substantially perpendicularly with respect to foot 112 to contact and cover an edge of a second upper surface 302 of second floor element 300.

In addition, both first arm 114 and second arm 116 can be configured to accommodate a range of height differences between first floor element 200 and second floor element 300. In particular, a first lower surface 115 of first arm 114 can be oriented at a non-zero, acute angle with respect to a plane perpendicular to foot 116. For example, the angle can be about 15 degrees, but it should be recognized that other angles (e.g., angles between about 5 and 30 degrees) can be considered desirable in various situations. Regardless of the specific angle and shape, when first arm 114 is positioned to contact and cover the edge of first upper surface 202, at least a portion of first lower surface 115 can be separated from first upper surface 202. In this way, first arm 114 need not be precisely designed to lie flush against first upper surface 202. Rather, the spacing allowed between first lower surface 115 and first upper surface 202 can effectively act as a buffer space that can account for variations in the relative dimensions of first floor element 200 with respect to second floor element 300. As a result, this spacing can allow first arm 114 to contact and cover the edge of first upper surface 202 at any of a variety of different angles without compromising the ability of first arm 114 to provide a smooth (i.e., substantially seamless) transition between reducer 100 and first floor element 200.

In comparison, it is noted that conventional reducers generally have a top surface that is substantially parallel to the upper surface of the underlying structure and also to the under-surface of the high-side arm. As a result, such reducers are generally limited to coupling flooring elements having only small ranges in flooring height differences (e.g., less than about 3 mm). In contrast, because first arm 114 of reducer 100 has both a greater thickness compared to the thickness of second arm 116 and an angled profile, reducer 100 can provide a substantially smooth transition between flooring elements having even greater differences in height (e.g., differences of 3 mm or more and even differences of 8 mm or more).

Similarly, second arm 116 can comprise a second lower surface 117 configured such that when second arm 116 is positioned in contact with second upper surface 302 of second floor element 300, at least a portion of second lower surface 117 can be spaced from second upper surface 302. In this way, this spacing between second lower surface 117 and second upper surface 302 can allow second arm 116 to contact and cover the edge of second upper surface 302 at any of a variety of different angles without compromising the ability of second arm 116 to provide a smooth transition between reducer 100 and second floor element 300.

To help position reducer 100 between first and second floor elements 200 and 300, a securing element (e.g., a metal clamp, track, or rail), such as for example securing element 120, can be coupled to subfloor 400 within the gap formed between first and second floor elements 200 and 300. Securing element 120 can be coupled to subfloor 400 by fasteners, such as screws, nails, glue, or any other conventional coupling method. Securing element 120 and foot 112 can be cooperatively formed so that foot 112 can be slideably movable within securing element 120 without being removed. For example, securing element 120 can where desired be provided with in-turned ends designed to grab the outer surface of foot 112 to resist separation in a vertical direction. Furthermore, foot 112 can have a substantially dove-tail shape, having the shorter parallel edge joined to first and second arms 114 and 116, and securing element 120 can be a channeled element having a corresponding shape as to mate with foot 112 and hold it in place.

Alternatively, securing element 120 can take the form of a key (e.g., an inverted T-element) configured to mate with a corresponding groove in an end of foot 112 (or vice versa), such that friction between the key and the groove secures reducer 100 in place. In addition, each of securing element 120 and the mating section of foot 112 can be provided with notched or barbed edges to simultaneously assist in mating and resist disassembly. In yet a further alternative, securing element 120 can be omitted where reducer 100 can be affixed directly to one or both of first or second floor elements 200 or 300 (e.g., by an adhesive). It is noted, however, that it can be desirable for reducer 100 to not be secured to one or both of first or second floor elements 200 or 300, so as to permit a degree of relative movement (i.e., “floating”), between first and second floor elements 200 and 300.

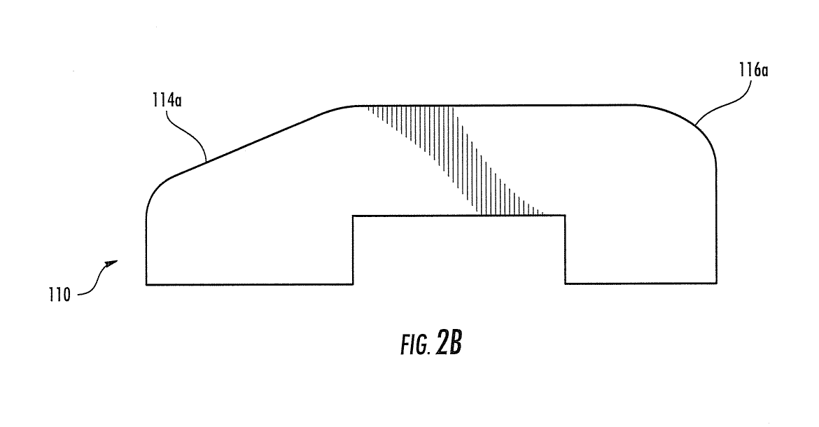

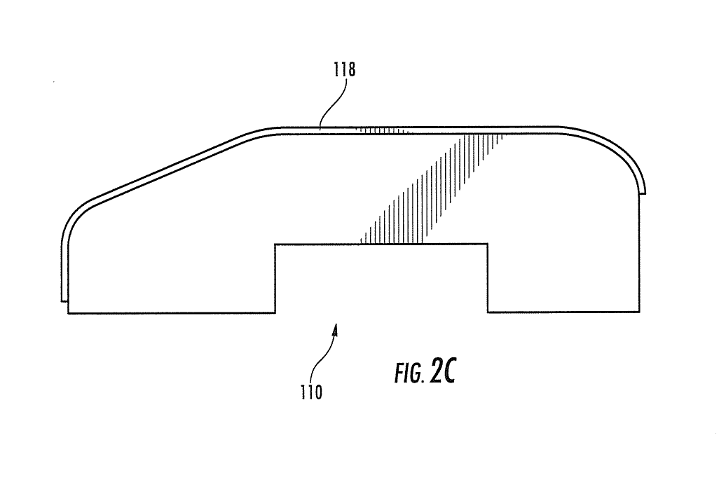

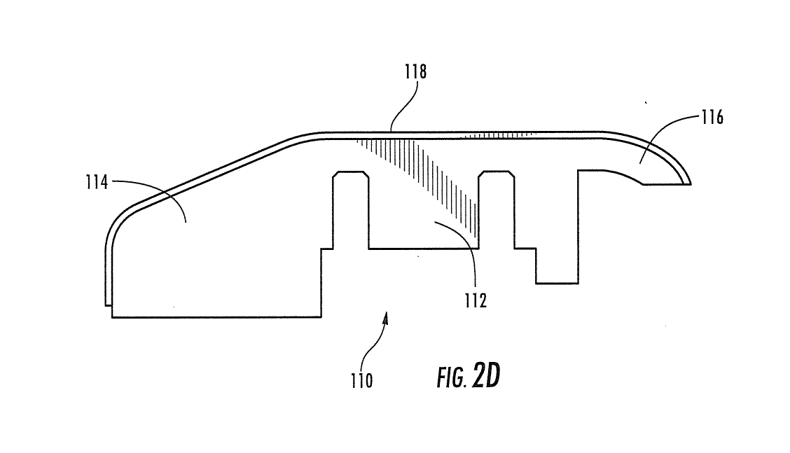

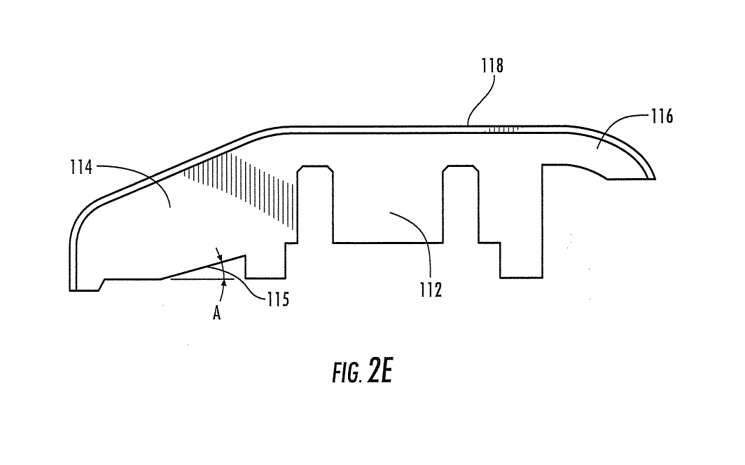

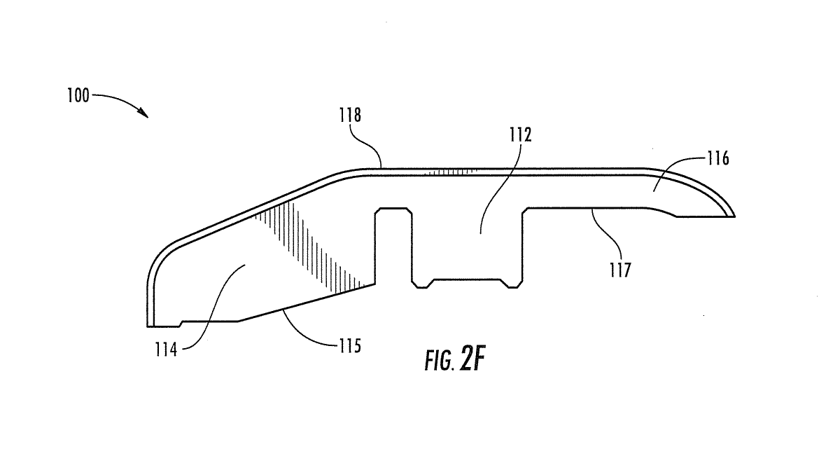

In another aspect, the present subject matter provides a method for producing a multi-purpose reducer, such as reducer 100 discussed above. Referring to FIGS. 2A and 2B, it is shown that one or more longitudinal carrier, generally designated 110, can be provided as the base element from which reducer 100 can be produced. Carrier 110 can be machined from a fiber board or other substrate material such as by a milling machine, or it can be extruded. The fiber board can be a water resistant board of so-called medium density fiber board quality (MDF-quality) or high density fiber board quality (HDF quality), each of which are made of finely divided fibers with an adhesive to bond the fibers together. It should be recognized, however, that reducer 100 can be formed of any suitable, sturdy material, such as wood, wood veneer, metal, polymer, fiberboard, plywood, or even a wood/polymer composite, such as strand board or strawboard.

Regardless of the specific material from which carrier 110 is produced, the general shape desired for reducer 100 can be defined in this first machining process or method. Namely, carrier 110 can be formed so that a first end defines a first surface profile 114a corresponding to the desired upper shape of first arm 114 and a second end defines a second surface profile 116a corresponding to the desired upper shape of second arm 116. As shown in FIG. 2B, for example, first surface profile 114a can define a generally downward-sloping surface corresponding to the generally angled shape of first arm 114, whereas second surface profile 116a can be substantially planar with the exception of a rounded edge.

With the basic shape of carrier 110 defined, a decorative surface can be provided thereon. For example, the decorative surface can be directly printed on carrier 110. Alternatively, a strip of post-forming laminate 118 can be attached to carrier 110 as shown in FIG. 2C. In particular, laminate 118 can comprise an overlay paper of α-cellulose (e.g., with a surface weight of about 25 g/m²), the overlay paper being impregnated with an aqueous solution of melamine-formaldehyde resin (e.g., to a resin content of about 70 percent by weight calculated on dry impregnated paper). Immediately after the impregnation, aluminum oxide particles (e.g., with an average particle size of about 50 μm) can be applied to the upper side of the paper (e.g., in an amount of about 7 g/m²) such as by a doctor-roll placed above the paper web. Thus, the hard aluminum oxide particles can then be applied to the still-wet melamine-formaldehyde resin which has not dried.

By comparison, a roll of conventional non-transparent decor paper with a decor pattern printed thereon (e.g., having a surface weight of about 80 g/m²) can be treated in the same way as the overlay paper except for the fact that no aluminum oxide particles are applied and that the resin content can be about 50 percent by weight calculated on dry impregnated paper.

The impregnated paper web can be fed continuously into a heating oven, where the solvent in the resin evaporates. Simultaneously, the resin can be partially cured to so-called B-stage. Thereby, the aluminum oxide particles can be enclosed in the resin layer and accordingly concentrated to the surface of the product obtained, which is usually called a prepreg. The prepreg web obtained can then be rolled again.

A roll of unimpregnated parchment (e.g., with a surface weight of about 120 g/m²) can be used at the production of the post-forming laminate. The two prepreg webs impregnated with melamine-formaldehyde resin and the unimpregnated parchment web can then be pressed between two press bands of a continuous laminating press to a decorative post-forming laminate. At the pressing, a prepreg web of α-cellulose can be placed on top with the side with the hard particles directed upwards. A prepreg web of decor paper and a web of parchment can be provided underneath. The prepreg webs and the parchment web can be pressed together (e.g., at a pressure of 35 kp/cm² and at a temperature of 170° C.). The decorative post-forming laminate obtained can then be cut with roller knives to strips of suitable length and width.

Laminate 118 can be attached to carrier 110, such as using a heat and moisture resistant glue. The attachment can be performed under heat and pressure, with the pressure being regulated with rolls which press laminate 118 against carrier 110, and the temperature can be regulated with heating nozzles which blow an even current of warm air. Following this process, the abrasion resistance of laminate 118 obtained can be measured, and a value for the IP-point amounting to 7000 revolutions can be obtained.

As shown in FIGS. 2D through 2F, carrier 110 can be further formed to define the sub-surface features of finished reducer 100. Specifically, referring to FIG. 2D, carrier 110 can be milled or otherwise formed to define foot 112 and second arm 116, with second arm 116 having a particular second thickness and a profiled second lower surface 117. As shown in FIG. 2E, the thickness and angled profile of first arm 114 can be established. Specifically, as indicated above, first arm 114 can define a first lower surface 115 that can be oriented at an angle with respect to a plane perpendicular to foot 112 (i.e., a plane parallel to second arm 116). For example, second lower surface 115 can define an acute angle A with respect to a plane perpendicular to foot 112 of about 15 degrees, although other angles (e.g., angles between about 5 and 30 degrees) can be used as well. Finally, as shown in FIG. 2F, further shaping can be performed to create reducer 100 in its final desired form. It should be noted that although FIGS. 2D through 2F indicate that laminate 118 is attached before the processing steps shown, carrier 110 can be formed into the desired shape before the post-forming of the laminate is commenced.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A multi-purpose reducer for covering a gap between two floor elements having different flooring heights, the reducer comprising:
a foot configured to fit in a gap between adjacent floor elements;
a first arm extending in a first direction from the foot, the first arm defining a first thickness, and the first arm comprising a first lower surface that forms an acute angle with respect to a plane perpendicular to the foot; and
a second arm extending in a second direction substantially perpendicularly from the foot, the second arm defining a second thickness less than the first thickness.

2. The reducer of claim 1, wherein the first arm extends in a first direction that slopes downwardly with respect to a plane perpendicular to the foot.

3. The reducer of claim 1, wherein the first lower surface is angled between about 5 and 30 degrees with respect to a plane perpendicular to the foot.

4. The reducer of claim 3, wherein the first lower surface is angled about 15 degrees with respect to a plane perpendicular to the foot.

5. A flooring system for covering a gap between two floor elements covering a subsurface and having different flooring heights, the system comprising:
a multi-purpose reducer comprising:
a foot configured to fit in a gap between a first floor element and a second floor element covering a subsurface;
a first arm extending in a first direction from the foot towards the first floor element, the first arm defining a first thickness, and the first arm comprising a first lower surface that forms an acute angle with respect to a plane perpendicular to the foot; and
a second arm extending in a second direction substantially perpendicularly from the foot towards the second floor element, the second arm defining a second thickness less than the first thickness; and
a securing element coupled to the subsurface between the first floor element and the second floor element, the securing element configured for maintaining the foot in a position between the first floor element and the second floor element.

6. The flooring system of claim 5, wherein at least a portion of the first lower surface is configured to be spaced apart from a first top surface of the first floor element.

7. The flooring system of claim 5, wherein the second arm comprises a second lower surface, at least a portion of the second lower surface being configured to be spaced apart from a second top surface of the second floor element.

8. A method for producing a multi-purpose reducer for covering a gap between two floor elements having different flooring heights, the method comprising:
producing a longitudinal carrier having an upper surface defining a first end having a substantially sloped profile and a second end having a substantially planar profile;
providing a decorative surface on the carrier;
shaping the carrier to define a foot;
shaping the first end of the carrier to define a first arm extending in a first direction from the foot, the first arm defining a first thickness, and the first arm comprising a first lower surface that forms an acute angle with respect to a plane perpendicular to the foot; and
shaping the second end of the carrier to define a second arm extending in a second direction substantially perpendicularly from the foot, the second arm defining a second thickness less than the first thickness.

9. The method of claim 8, wherein producing a longitudinal carrier comprises machining the carrier from a material selected from the group comprising medium density fiber board, high density fiber board, wood, wood veneer, metal, polymer, plywood, or a wood/polymer composite.

10. The method of claim 8, wherein providing a decorative surface on the longitudinal carrier comprises printing a decorative pattern on the longitudinal carrier.

11. The method of claim 8, wherein providing a decorative surface on the longitudinal carrier comprises attaching a post-forming laminate to the upper surface of the carrier.

12. The method of claim 11, wherein attaching a post-forming laminate comprises attaching a laminate comprising an overlay paper of α-cellulose impregnated with melamine-formaldehyde resin, aluminum oxide particles, and at least one second paper layer.

13. The method of claim 11, wherein attaching a post-forming laminate comprises gluing the laminate to the carrier.

14. The method of claim 13, wherein gluing the laminate to the carrier comprises applying a heat and moisture resistant glue between the carrier and the laminate and pressing the laminate against the carrier under heat and pressure.

15. The method of claim 8, wherein shaping the first end comprises shaping a first lower surface of the first end to define an angle of between about 5 and 30 degrees with respect to a plane perpendicular to the foot.

16. The method of claim 15, wherein shaping the first end comprises shaping a first lower surface of the first end to define an angle of about 15 degrees with respect to a plane perpendicular to the foot.

17. The method of claim 8, wherein one or more of shaping the carrier to define a foot, shaping the first end, or shaping the second end comprises milling the carrier.
